(19) United States
(12) Patent Application Publication
(10) Pub. No.: US 2007/0143786 A1
(43) Pub. Date: Jun. 21, 2007

(54) EMBEDDED ADVERTISEMENTS AND METHOD OF ADVERTISING

(75) Inventors: Andrew Isaac Deitsch, Lake in the Hills, IL (US); Stephen John Angelovich, Yonkers, NY (US); David Bret Rabinowitz, Huntington, NY (US); John Patrick Wallace, Hamburg, NJ (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/552,700

(22) Filed: Oct. 25, 2006

Related U.S. Application Data
(60) Provisional application No. 60/751,317, filed on Dec. 16, 2005.

(51) Int. Cl. H04N 7/173; H04N 5/445; H04N 7/025; G06F 13/00; H04N 7/10; G06F 3/00

(52) U.S. Cl. 725/32; 725/42; 725/114

(57) ABSTRACT

A technique is provided for advertising. The technique includes a combining of two or more video streams to form a unified video stream and broadcasting the unified video stream. At least one of the two or more video streams is a program content stream comprising program content that is filmed by a camera and at least one of the two or more video streams is an advertisement material stream comprising advertisement material. The placement of the advertisement material stream relative to the program content stream is independent of any information derived from the camera.

### CROSS REFERENCE TO RELATED APPLICATIONS

This application claims the benefit of U.S. Provisional Application No. 60/751,317 filed on Dec. 16, 2005, which is incorporated herein in its entirety by reference.

### BACKGROUND

The invention relates generally to advertising and more particularly to embedded advertisements and techniques for advertising the same.

In the field of television broadcasting, a key source of revenue is billable content, referred to as advertising, in which a broadcaster delivers a certain number of eyeballs (viewers) to advertisers. Currently advertising or commercial spots include discrete video clips interleaved in time with programming content that are sold to the advertisers and subsequently shown during the program broadcast. For example, as shown in FIG. 1, advertising time slots (such as 10, 15, 30, 60, 120 second time slots) are listed in the sales system. The sales team sells the available time slots from the sales system. The sold time slots are sent to the traffic system. The traffic system scheduler automatically places the sold time slots on a Log (logic built-in). The copy process begins once the Log is created and the traffic system, in collaboration with the advertising agency, assigns an industry standard commercial identification (ISCI) number to the time slots. The traffic system finalizes the Log and publishes to master control. The master control reviews the Log and verifies ISCI number in-house using an automated routine. The program is finally aired and the traffic system reconciles the original Log and the actual on-air Log. An invoice is then generated by the traffic system at the month end. However, the discrete advertising time can be ignored, skipped, or otherwise not viewed during the broadcasting of the program. For example, by use of techniques, such as those employed by TiVo, advertisements may be skipped or may be fast forwarded while viewing or recording the program.

The use of independent video images, embedded in the program stream is currently being used for news alerts and other non-revenue related programming. However, this approach has not been used for advertising and other revenue purposes. Further, sales departments currently are incapable of performing direct advertisement in program content other than through product placement within the content. In other words, the sales departments cannot directly sell advertisement during the presentation of content. Additionally, current techniques for embedding advertisement into the program content require some information from the camera to enable the placement of the advertisement relative to the program content.

It is therefore desirable to provide advertisement techniques that cannot be ignored or skipped while viewing the program. It is also desirable to provide a technique to facilitate the process of selling and broadcasting such advertisements during the program.

### SUMMARY

Briefly in accordance with one aspect of the invention, a method is provided for advertising. The method provides for a combining of two or more video streams to form a unified video stream and broadcasting the unified video stream. At least one of the two or more video streams is a program content stream comprising program content that is filmed by a camera and at least one of the two or more video streams is an advertisement material stream comprising advertisement material. The placement of the advertisement material stream relative to the program content stream is independent of any information derived from the camera. Systems and computer programs that afford functionality of the type defined by this method may be provided by the present technique.

In accordance with another aspect of the invention, a method is provided for advertising. The method provides for integrating traffic, sales, marketing and production teams to generate an advertisement video stream, combining a program content video stream comprising a program content and the advertisement video stream to generate a unified video stream, and broadcasting the unified video stream. Systems and computer programs that afford functionality of the type defined by this method may be provided by the present technique.

In accordance with a further aspect of the invention, a method is provided for advertising. The method provides for listing one or more advertising opportunities in a sales system, tracking and selling the listed advertising opportunities from the sales system, creating traffic log for the sold advertising opportunities, generating an advertisement video stream for the sold advertising opportunities, integrating, via a traffic system, the advertisement video stream and a program content video stream to generate a unified video stream, and broadcasting the unified video stream.

In accordance with an additional aspect of the invention, a method is provided for advertising. The method provides for listing one or more advertising opportunities in a sales system, tracking and selling the listed advertising opportunities from the sales system, creating traffic log for the sold advertising opportunities, integrating traffic, sales, marketing and production teams to generate an advertisement video stream for the sold advertising opportunities, storing the advertisement video stream in a system with an identification number, sending notification of the advertisement video stream to the traffic, the sales, the marketing and the production teams, taking the advertisement video stream from the system and integrating it into a program content video stream via a traffic system to generate a unified video stream, finalizing a Log and publishing to a master control via the traffic system, reviewing the Log and verifying the advertisement video stream via the master control, broadcasting the unified video stream to a plurality of viewers over a network, reconciling original Log and actual on-air Log via the traffic system, and generating an invoice via the traffic system based on the number of viewers watching the unified video stream.

These and other features, aspects, and advantages of the invention will become better understood when the following detailed description is read with reference to the accompanying drawings.

### BRIEF DESCRIPTION OF THE DRAWINGS

FIG. 1 is a block diagram of a traditional advertising process.

FIG. 2 is a diagrammatical representation of embedding advertisement in program content and broadcasting the program content with the embedded advertisement to viewer in accordance with aspects of the invention.

FIG. 3 is a block diagram of an exemplary advertising process in accordance with aspects of the invention.

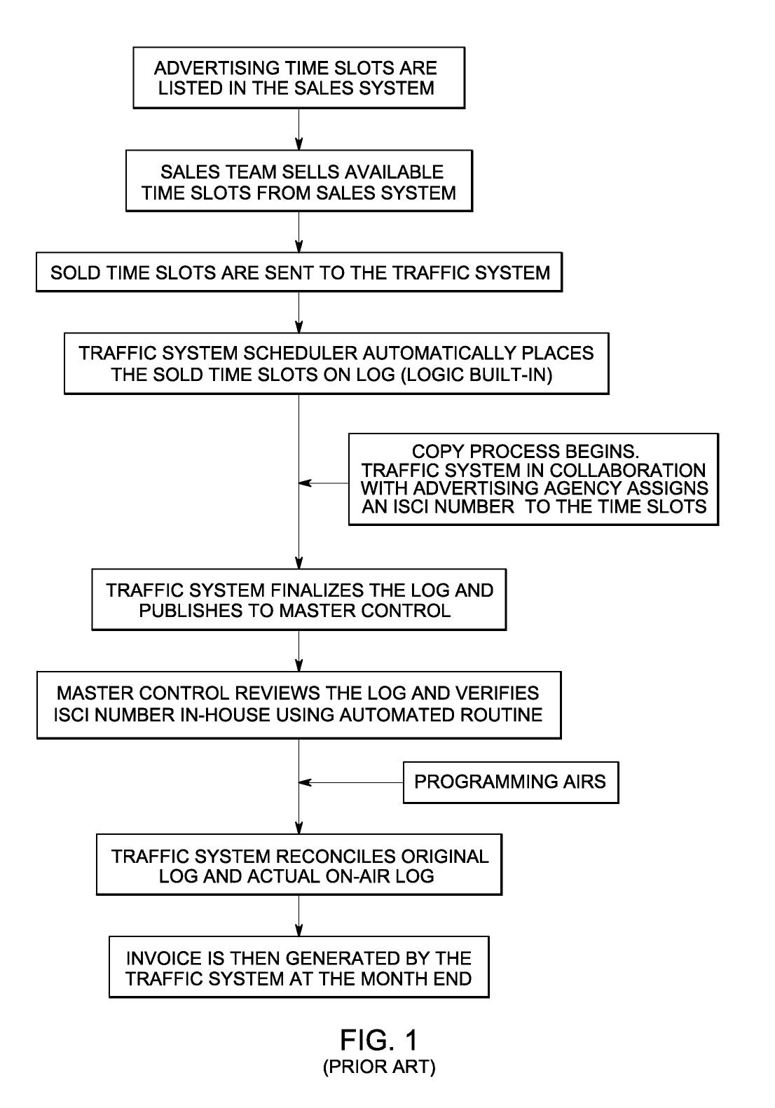

### DETAILED DESCRIPTION OF EXEMPLARY EMBODIMENTS

The present techniques are generally directed to embedded advertisements and a method of advertising to facilitate the process of selling and broadcasting such advertisements during programming. Such advertisement techniques may be useful in a variety of broadcasting contexts, such as television network, Internet, cable network, and others. Though the present discussion provides examples in a television network context, one of ordinary skill in the art will readily apprehend the application of these techniques in other contexts, such as for cable network or Internet, is well within the scope of the invention.

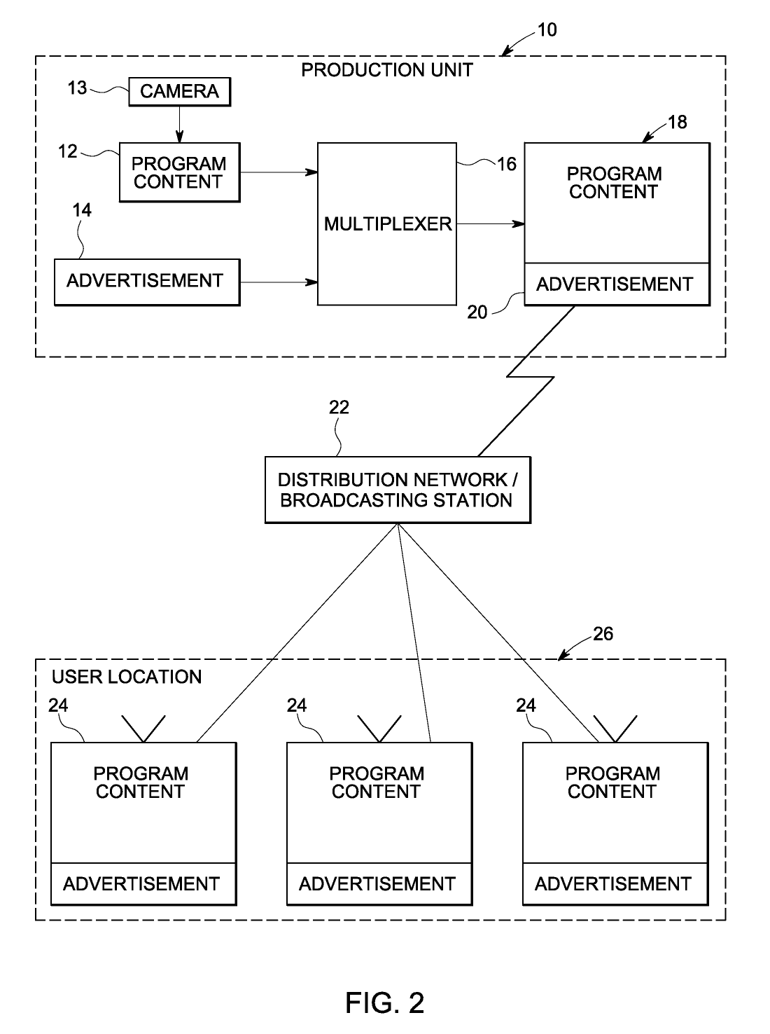

Referring now to FIG. 2, a diagrammatical representation of embedding advertisement in program content and broadcasting the program content with the embedded advertisement to viewer is illustrated in accordance with aspects of the invention. At a production station 10, two separate video streams are simultaneously generated, one containing program content 12 that is filmed by a camera 13, and the other the advertising material 14. The advertising video stream 14 is inserted into or embedded over the program content video stream 12 using a multiplexing device 16. The resulting unified video stream 18 contains both advertising and program content. The inserted or embedded advertising video stream 14 is delivered in the unified video stream 18 as an advertisement portion 20 of the program screen, referred to as “Snipes”, dedicated to the display of an advertising message (embedded advertisement). It should be noted that the placement of the advertisement material stream 14 relative to the program content stream 12 is independent of any information derived from the camera 13. Further, it should be noted that the Snipes may be a static or a dynamic image. The unified video stream 18 is then sent to a distribution network or a broadcasting station 22 for transmission to one or more viewers 24 at different viewer locations 26. The one or more viewers 24 may receive the unified video stream 18 containing the embedded advertisement portion 20 from the broadcasting station 22 via cable, satellite or other transmission medium.

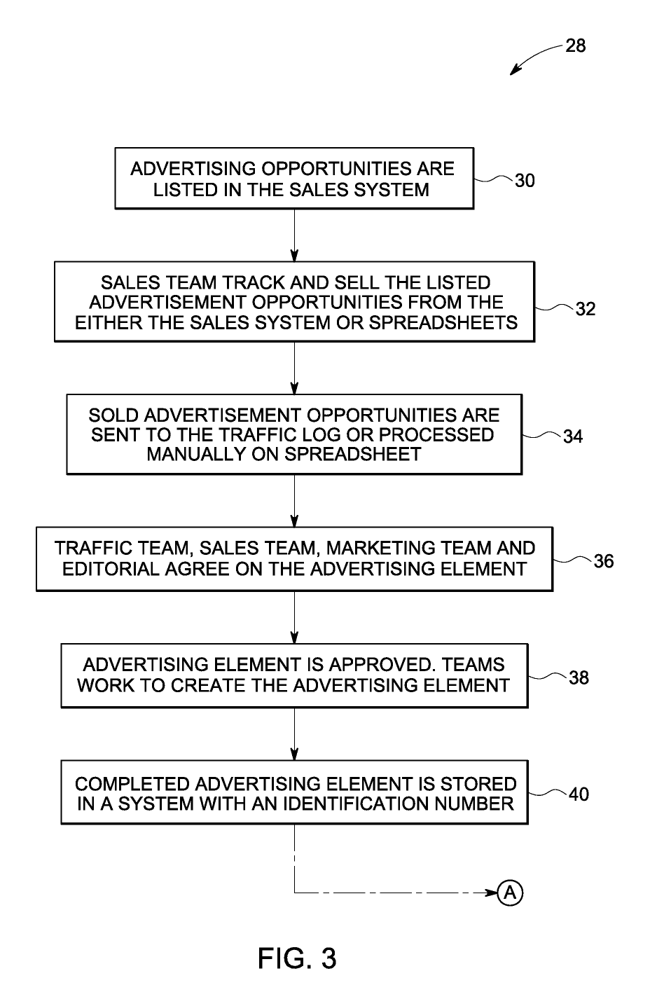

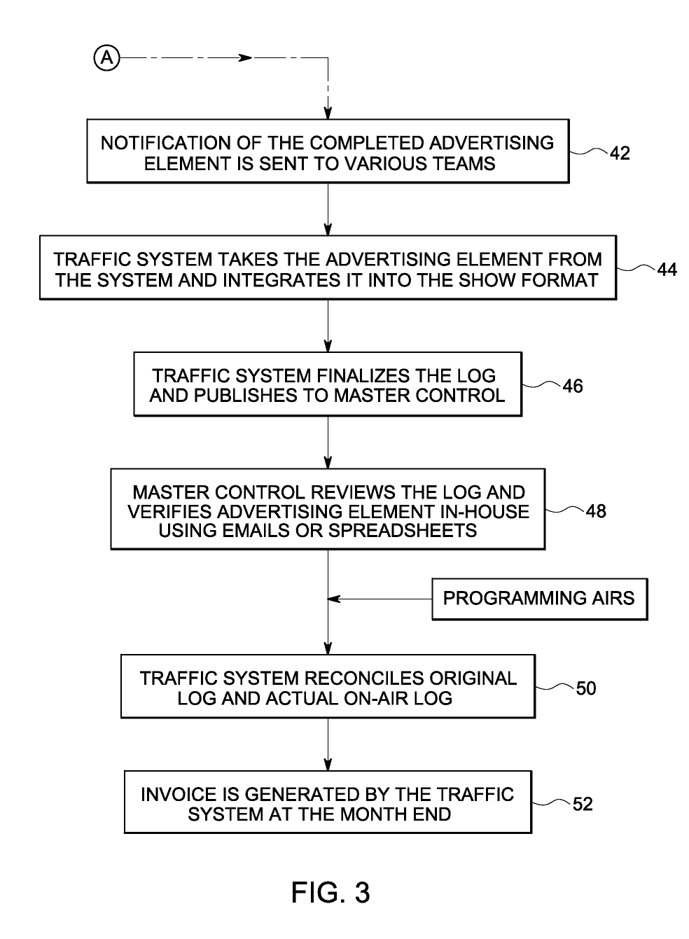

The embedded advertisements as well as traditional advertisements may be sold, broadcasted and/or billed via a variety of techniques. In one embodiment, a technique is provided to facilitate the process of selling and broadcasting such advertisements during the program. For example, FIG. 3 illustrates an exemplary advertising process 28 in accordance with aspects of the present technique. The process begins by listing advertising opportunities, such as placement of embedded advertisements in a certain program or placement of the advertising time slots between programs, in the sales system at block 30. The sales team tracks and sells the listed advertisement opportunities from either the sales system or spreadsheets at block 32. The sold advertisement opportunities are then sent to the traffic Log or may be processed manually on spreadsheet at block 34. Further, the traffic team, sales team, marketing team and editorial team may reach an agreement on the advertising element at block 36. Once the advertising element is approved, the different teams work to create the advertising element at block 38. It should be noted that the advertising element may be created at a production house or may be created by an outside vendor. The completed advertising element is then stored in a system with an identification number at block 40. The process 28 further continues be sending notification of the completed advertising element to various teams via email or other communication medium at block 42. The traffic system then takes the advertising element from the system and integrates it into the show format at block 44. As will be appreciated by one skilled in the art, in certain embodiments, integrating the advertisement video stream into the program content video stream may be achieved by combining the advertisement video stream and the program content video stream using a multiplexing device. Additionally, it should be noted that, in certain embodiments, the placement of the advertisement material stream relative to the program content stream may be independent of any information derived from a camera that is employed to film the program content. Further, the traffic system finalizes the Log and publishes to a master control at block 46. The master control reviews the Log and verifies advertising element in-house using emails or spreadsheets at block 48. The program is finally aired and the traffic system reconciles the original Log and the actual on-air Log at block 50. An invoice is then generated by the traffic system at the month end at block 52. As will be appreciated by one skilled in the art, the placement of the advertisements within the various programs may be done manually or may be automated via suitable routines.

The techniques described in the embodiments discussed above outline the use of embedded, visible and invisible encoded signals, including video and audio, to convey advertising information in a video and/or electronic digital image and the application of this video technology and architecture applied to the delivery of advertising and commercial information. As will be appreciated by one skilled in the art, the advertising techniques described in the various embodiments discussed above provides transparent, indelible integration of advertising content and program content. This insures that the advertising content is delivered and viewed, along with the program content without disruption, or avoidance. The advertising content cannot be skipped or otherwise removed from the program content.

Further, as will be appreciated by one skilled in the art, the techniques described in the various embodiments discussed above empower the salesperson to sell either time slots or embedded advertisements. The techniques combine selling all the way through the production process, thereby providing an integrated environment for sales and production process.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A method of advertising, comprising:
combining two or more video streams to form a unified video stream, wherein at least one of the two or more video streams is a program content stream comprising program content that is filmed by a camera and at least one of the two or more video streams is an advertisement material stream comprising advertisement material, and wherein the placement of the advertisement material stream relative to the program content stream is independent of any information derived from the camera; and
broadcasting the unified video stream.

2. The method of claim 1, wherein combining the two or more video streams comprises combining two or more video streams using a multiplexing device.

3. The method of claim 1, wherein broadcasting comprises broadcasting the unified video stream to a plurality of viewers over a network.

4. The method of claim 1, further comprising integrating traffic, sales, marketing and production teams to generate the advertisement material stream.

5. The method of claim 1, further comprising generating an invoice based on the number of viewers watching the unified video stream.

6. A method of advertising, comprising:
integrating traffic, sales, marketing and production teams to generate an advertisement video stream comprising an advertisement;
combining a program content video stream comprising a program content and the advertisement video stream to generate a unified video stream; and
broadcasting the unified video stream.

7. The method of claim 6, wherein combining comprises combining the advertisement video stream and the program content video stream using a multiplexing device.

8. The method of claim 7, wherein the placement of the advertisement material stream relative to the program content stream is independent of any information derived from a camera that is employed to film the program content.

9. The method of claim 6, wherein broadcasting comprises broadcasting the unified video stream to a plurality of viewers over a network.

10. The method of claim 6, further comprising generating an invoice based on the number of viewers watching the unified video stream.

11. A method of advertising, comprising:
listing one or more advertising opportunities in a sales system;
tracking and selling the listed advertising opportunities from the sales system;
creating traffic log for the sold advertising opportunities;
generating an advertisement video stream for the sold advertising opportunities;
integrating, via a traffic system, the advertisement video stream and a program content video stream to generate a unified video stream; and
broadcasting the unified video stream.

12. The method of claim 11, wherein generating the advertisement video stream for the sold advertising opportunities comprises integrating traffic, sales, marketing and production teams to generate the advertisement.

13. The method of claim 12, wherein the traffic, the sales, the marketing and the production teams plan an advertising element, approve the advertising element and work together to create the advertising element.

14. The method of claim 13, further comprising storing the generated advertisement element in a system with an identification number.

15. The method of claim 14, further comprising sending notification of the generated advertisement element to the traffic, the sales, the marketing and the production teams.

16. The method of claim 15, wherein integrating the advertisement video stream and the program content video stream comprises taking the generated advertisement element from the system and integrating it into show format via the traffic system.

17. The method of claim 11, wherein integrating comprises combining the advertisement video stream and the program content video stream using a multiplexing device.

18. The method of claim 17, wherein the placement of the advertisement material stream relative to the program content stream is independent of any information derived from a camera that is employed to film the program content.

19. The method of claim 11, wherein the traffic system finalizes a Log and publishes to a master control.

20. The method of claim 19, wherein the master control reviews the Log and verifies the advertisement video stream.

21. The method of claim 11, wherein broadcasting the unified video stream comprises reconciling original Log and actual on-air Log via the traffic system.

22. The method of claim 11, further comprising generating an invoice via the traffic system based on the number of viewers watching the unified video stream.

23. A method of advertising, comprising:
listing one or more advertising opportunities in a sales system;
tracking and selling the listed advertising opportunities from the sales system;
creating traffic log for the sold advertising opportunities;
integrating traffic, sales, marketing and production teams to generate an advertisement video stream for the sold advertising opportunities;
storing the advertisement video stream in a system with an identification number;
sending notification of the advertisement video stream to the traffic, the sales, the marketing and the production teams;
taking the advertisement video stream from the system and integrating it into a program content video stream via a traffic system to generate a unified video stream;
finalizing a Log and publishing to a master control via the traffic system;
reviewing the Log and verifying the advertisement video stream via the master control;
broadcasting the unified video stream to a plurality of viewers over a network;
reconciling original Log and actual on-air Log via the traffic system; and
generating an invoice via the traffic system based on the number of viewers watching the unified video stream.

24. The method of claim 23, wherein integrating the advertisement video stream into the program content video stream comprises combining the advertisement video stream and the program content video stream using a multiplexing device, wherein the placement of the advertisement material stream relative to the program content stream is independent of any information derived from a camera that is employed to film the program content.
